(19) United States
(12) Patent Application Publication
(10) Pub. No.: US 2010/0300400 A1
(43) Pub. Date: Dec. 2, 2010

(54) ROTARY INTERNAL COMBUSTION ENGINE

(76) Inventor: Jose Fernando Bittencourt, Rio de Janeiro (BR)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 12/738,420

(22) PCT Filed: Apr. 2, 2008
(86) PCT No.: PCT/BR08/00095

§ 371 Date: Aug. 11, 2010

(30) Foreign Application Priority Data
Oct. 17, 2007 (BR) PI-0704879-3

(51) Int. Cl. F02B 53/00

(52) U.S. Cl. 123/242

(57) ABSTRACT

Internal Combustion Engine, Rotary Engine Type, with Distinct Conception, Durability and Performance, Applied to all Types of Vehicle or Industrial Equipment, represented by an inventive solution of a rotary engine, which aggregates value by promoting a distinct conception and reliability to an engine based on the functional concept of this nature, thus providing a greater durability to the engine, levering the same one to a condition of singular competitiveness, where to this attribute be obtained, its innovation is related to a constructive concept based on the formation of a set of divisors components (17), mainly divisors components of chambers, which are distinct by promoting a radial movement with perpendicular angle (Θ2) constant equal to 90° related to the internal cavity of the jacket (6), which is perfectly cylindrical, in all kinematics of movement, which describes its functionality, mainly when it describes the phases of intake; compression; explosion/expansion and also depletion, respectively, being this inedited condition of perpendicularity is obtained due to a peculiar constructive concept, defined by a rotor component (13), which can present a cylindrical shape, where its fissures (13a), which allow the free movements of the divisor components (17), having this rotor (13) an orbital movement resulting from the action of the cam of the main axis component, crankshaft type (8), and rotation movement around its own axis, resulting from the interference between the fixed planetary gear (20) assembled to a static element of the engine (A) and the satellite gear (13c) fixed to this rotor component (13), whose synchronized combination of the referred movements allows the chambers (F), formed among each pair of divisors (17) and the sectors of the rotor (13) and of the jacket (6), defined by this pair of divisors, expand and contract in defined moments and points of the functional cycle, generating the phases of intake, compression/explosion, expansion and depletion (exhaustion), phases that perform the classical phases of an internal combustion engine or “explosion engine”, two- or four-stroke-cycle.

The present demand of invention of the referred title and object of description and claim in this document is related to an inventive solution to internal combustion engine, mainly to internal combustion engine technically known as “rotary engine”, applied to vehicle or industrial equipment and other applications where internal combustion engines are necessary.

The rotary engine with distinct conception, durability and performance is different from any other engine of this nature by having a revolutionary conception and by presenting highlighted attributes, such as excellent tightness between chambers, reliability with high yield, low mechanical losses and peculiar qualities, whose realization is industrially and economically possible to all classes of possible specifications to engines that present the concept of transforming energy from a chemical reaction in mechanical energy through the cycle of intake, compression, explosion/expansion and exhaust/flow of a combustible/comburent mixture inside the combustion chambers.

Its distinct conception and reliability may be translated by the obtainment of a rotary engine with peculiar durability and high yield, which presents superior or equal operational life when compared to the traditional and practically monopolist piston rotary engines.

Related to the aspect of quality the inedited rotary engine now claimed presents distinct performance, excellent tightness between the chambers, as well as low noise level, and also an adequate consumption of combustible to be burned during the continuous cycles of explosion. Also in the scope of excellence of the performance, it is verified that this limited consumption of combustible is translated in a reduction of gases volume and particulate matter exhausted by the functional cycle of the engine, being in accordance with the current imperative needs of ecologically and economically qualified solutions.

Also related to the quality, we have the rotary engine now invented presents a peculiar condition of functionality related to the ergonomic usage, since it presents low levels of noise and vibration, providing comfort to the users of the equipment which is driven by this engine, mainly to drivers and passengers of vehicles.

The sum of the attributes, now introduced in this topic, provides to the rotary engine a condition of high competitiveness in the market where there are several motorization solutions, which this competitiveness is increased by the fact its concretization involves an industrial cost almost equivalent, or even inferior, to the perceived cost of manufacturing rotary engines, such as the “Wankel”-type, the most highlighted current model of this concept of engine, which naturally presents reduced cost when considering the paradigm of comparison with rotary engines.

Thus it is conclusive that the rotary engine with distinct performance, durability and conception has the characteristic of innovation, inventive activity and industrial and commercial applicability, accomplishing the patentability requirements, mainly of a patent of invention, according to 8^{th} article of Law 9.279 (Lei de Patentes, Marcas e Direitos Conexos), May 14, 1996.

### TECHNICAL BACKGROUND

In order to provide veracity to the context explained in the Introduction section, an explanation will be made about the state of technique of the engines, mainly of the engines with the concept of internal combustion, also known as explosion engine, where it will be possible to a skilled technician to recognize its limitative aspects to, in a posterior moment, present the aggregated advantages with the introduction of the inedited distinct rotary engine considering the performance, durability, construction economy and combustible consumption, reliability and environment preservation aspects.

Internal combustion engines: also technically known as “explosion engines”, they can be translated as the machines with the function of providing mechanical energy and functionality to products such as industrial equipment and vehicles. They are fundamentally based on the combustion (explosion) of a combustible/comburent mixture inside a chamber, which can be ignited by sparks or high temperature.

Types of internal combustion engines: among the engines known as economically reliable and deeply commercialized, the engines that present a significantly high demand are the ones applied to vehicles. Among them we can highlight:

a) Two-stroke-cycle engine: a distinct engine by presenting high rotation and, consequently, high power, even with a simple constructive concept. Its operation may be understood by the two-stroke-cycle necessary to conclude a complete turn of the crankshaft.

This type of engine presents as a negative aspect that to obtain a high power, it demands high combustible consumption. At its turn it means a high emission rate of toxic gases and particulate matter to the atmosphere, which is against the current needs, which obligate the use of ecologically friendly products.

b) Four-stroke-cycle engine: it presents high power in relatively low rotation regimes, when compared to the two-stroke-cycle engine, but its constructive concept is characterized by presenting great number of component parts—static and movable ones. Its operation demands two complete turns of the crankshaft to complete a cycle.

Despite of being more economical from the point of view of consumption, these engines present high vibration level, high mechanical losses, as well as great number of component parts, which means higher industrial cost, as well as high maintenance costs and high probability of defects.

c) Diesel engine: this type of engine presents an operation based on the absorption of atmospheric air inside the combustion chamber, where its internal temperature is increased to more than 600° C., where the combustible (diesel) is directly injected inside the chamber and starts the explosion process.

Contrarily to the piston rotary engines, two-stroke-cycle and four-stroke-cycle not using diesel, this type of engine does not need a spark system to start the explosion process. However, in spite of being a deeply used engine, mainly to big vehicles and trucks, they visually present a great emission rate of gases and particulate matter to the atmosphere. They present very intensive vibrations and they necessarily need a construction that makes them heavy and noisy, mainly due to the high compression rates.

d) Rotary engine: it is characterized by presenting a simplified constructive concept related to the piston rotary engines, being these are characterized by presenting a rotor (or rotors) that performs rotation movements inside the jacket. It is generally extremely compact and light. However, its application to vehicles has faced restrictions, mainly regulatory ones, due to its combustible consumption and pollutant emission rates.

We can also mention other types of engine, such as jet engine; turbine (gas and aeronautic) and rocket engines, for example.

Considering the scope and object of the claim mentioned in the title, we will only consider the rotary engines. It is a fact that several different solutions exist to this type of engine, which uses this constructive and functional concept to internal combustion engines, presenting a lot of technical literature that, in a general way, shows that almost all of them present the basic concept of the rotary engine idealized, patented and constructed by Felix Wankel in the 1940s. We can observe that generally, as to the “Wankel” engines, these engines present the same problem of non-constant perpendicularity between the chamber divisors and the respective jacket, considerably impairing the sealing and internal cleaning, a fact that characterizes them as very pollutant and non-economical engines, which prevent the large scale production of these engines.

Considering this statement, the petitioner understands that is adequate a detailed study of the mentioned “Wankel” engine, where the analysis of its constructive concept and functionality will base the aggregated objective arguments to the now invented rotary engine, using the “Wankel” engine as the paradigm of this analysis.

Wankel engine: this rotary engine is characterized by presenting a constructive concept based on a single jacket, which describes a cavity whose profile describes an approximately 8-shape, where inside it a component rotor is assembled, which describes an approximately triangular shape that in a general way has the function of a piston component, used in the conventional alternative combustion engines.

At its turn, this rotor is assembled in a rotation axis, mainly an equivalent axis to a crankshaft component.

In order to assure the necessary sealing, to an efficient explosion cycle, the installation of a discreet sealing element in the end of each edge formed in the rotor triangular is performed.

Operational principle of the Wankel engine: this engine presents a four-stroke-cycle: intake, compression, explosion and exhaust. In order to obtain this cycle the triangular rotor describes a movement of eccentric turn related to the axis of the crankshaft component (main axis), making the edges of the rotor triangular describe a movement to an equidistant distance from the wall of the cavity (or jacket) of the chamber.

Thus, this eccentric displacement of the triangular rotor provokes an increase or decrease of the space between the convex sides of the rotor and the wall of the cavity of the jacket where, when this space is increasing, a hypothetic mixture is injected inside the chamber and starts to be compressed during the subsequent decrease of the volume of the chamber, in this manner creating the cycle, mainly the classical four-stroke-cycle previously mentioned.

Advantages of the Wankel rotary engines: among the several positive characteristics we can highlight:
Reduced vibration levels during its operation, being such attribute due to its constructive simplicity, with reduced number of interactive components, as well as the absence of movement inversion of defined components in the mechanism;
Due to its reduced number of component parts, it presents a compact assembly, creating a peculiar condition of assemblage in equipment and/or vehicle, and also allows obtaining a lower gravity center of the vehicle, collaborating to increase the freedom degrees in designs of aerodynamic nature;
It presents a superior rotation and torque;
It may present combustible consumption similar to equivalent piston rotary engines;
A more flexible power curve, when compared with the power curve of the piston rotary engines.

Disadvantages of the Wankel rotary engines: among the several negative characteristics we can highlight:
Impairment of the reliability due to its deficient sealing system among the edges of the rotor and walls of the cavities of the chamber (jacket);
Impairment of the durability since its sealing conception and the interaction between static (jacket) and movable (rotor triangular/sealing) components provoke a formation and accumulation of particulate matter;
Excessive engine heating due to the great internal area of the chamber, provoking a great heat exchange of the hot gas masses with the housing (jacket);
From the point of view of its conception, the Wankel rotary engine presents a constructive concept that plasters its technical specification, in a way of a limited rotor, forming 3 chambers to each jacket and a unique possible relation between the fixed gear and the dynamic gear, fixed to the rotor to each motor specification;
Difficulty of rigorously accomplishing the engineering specifications; and
It is necessary a high-precision assembly of the involved components, with very restrictive tolerances−practically nominal measures.

As we can see from the above arguments, it is a fact that the solutions of the rotary “Wankel” engines accomplish the primary objective, which is converting thermal energy in mechanical energy, providing movement to industrial equipment or vehicle. However, also in accordance with the previously exposed, it is a fact that such solutions present deficient aspects, mainly the obtainment of distinct reliability, durability and quality.

### PROPOSAL OF INVENTION

Considering all exposed in the Technical Background section, the petitioner idealized an inedited rotary engine, which uses in an optimized way the aggregated advantages of its functional concept, mainly the advantages of the Wankel rotary engines, duly explained in this document, where additionally it presents a constructive concept that consistently eliminates the negative aspects, also previously mentioned.

Thus, we can list as distinct and innovative aspects of the new rotary engine:

a) Equivalent and/or improved general performance of the motor;

b) Distinct durability due to a limited wearing of its component parts (movable or static ones), excellent sealing among the chambers, which significantly reduces the losses, as well as an excellent internal cleaning;

c) For items “a” and “b”, respectively, we can observe a reduction in the cost and frequency of maintenances, both predictive and corrective;

d) Reduction of the combustible consumption, where we must consider all classes of combustible, such as petroleum-based or also bio-combustible, mainly alcohol (from sugar-cane, corn and similar ones);

e) Minimization of the emission of pollutant gases and particulate matter to the atmosphere, being an ecological solution;

f) From the commercial point of view, the new constructive concept, idealized to a rotary engine, allows a greater flexibility of engine specifications, where the same one is adequate to any type of engineering specification, in accordance with the motor application;

g) Equivalent or inferior industrial cost when compared to the commercialized rotary engines, since in the manufacturing of its component parts the same materials, machines and tools are used; and

h) In accordance with the previous items, where the union of a distinct solution related to the performance, durability, reliability, combustible economy and low industrial cost places the new rotary engine in a distinct level of competitiveness, collaborating to a unique satisfaction degree of the final user.

As we can see, the list of advantages obtained with the new rotary engine is very solid and to make possible its constructive concept it presents technical aspects that have never been considered in solutions of rotary engines in the state of the technique, such aspects that will be revealed in this point of the document.

Paradigm of development: the petitioner based the invention on the observation of conceptions applied to the current rotary engines, and verified the causes that produce a deficient sealing system between the chambers, i.e., due to the mistaken conception the obtained form does not allow an ideal operation of the seals that separate the chambers, impairing the sealing in the contact point among the static and dynamic components of the engine.

Causes of the deficient sealing system: when monitoring the cycle of eccentric movement of the rotor component inside the chamber, the petitioner concluded that—using as comparison paradigm a Wankel rotary engine—the profile in 8-shape of the jacket cavity does not consider a relation of constant perpendicularity between the discreet stem of the sealing element and the wall of the cavity of the jacket in its whole outline, where this perpendicularity only occurs in discreet points of this cavity, when the rotor describes its eccentric movement.

The condition above presented allows affirming that during the functional cycle of the Wankel rotary engine, as well as in several other projects, there are moments when the sealing between the discreet stem of the sealing element and the wall of the cavity of the jacket is deficient, since the known sealing element presents design and functional characteristics that limit its efficiency. In the case of the Wankel engine, for example, this sealing element presents four unique conditions of perpendicularity between the discreet sealing element and the cavity of the jacket (these conditions are duly detailed and illustrated in the attached figures and in the respective section of Detailed Description of the invention). We can also see that the contact between the discreet sealing element in the edge of the rotor and the cavity (chamber), in the complete sequence of the cycle, is oblique and forms several contact angles. Such occurrence significantly impairs the efficiency of the sealing between the chambers.

Thus, the limited efficiency of the sealing system compromises the performance of the internal chambers during the classical cycle of intake, compression, explosion and exhaustion, a fact that produces several other functional problems as: durability, efficiency, reliability, consumption and pollutant emission.

Application of the inventive activity: after concluding that, the petitioner defined the conception of the new rotary engine that is based on the obtainment of an efficient sealing system between the static component part (jacket that coats the internal part of the cavity of the motor housing) and the movable component part (divisors of chambers), where a unique condition of perpendicularity during all functional cycle exists in the contact region between the jacket and the end of each divisor of chambers component with sealing elements.

Idealized constructive concept: the new constructive concept of the rotary engine presents an innovation characteristic, where to obtain the condition of perpendicularity between the end of the chamber divisor components with theirs extreme sealing elements and an internal wall of the jacket that coats the cavity of the housing it is mandatory a geometrical cylindrical condition to this cavity/jacket.

Additionally, the rotor component, which is assembled over the cam of a main axis, such as a crankshaft, may present any geometrical shape, such as cylindrical, elliptical or even polygonal, and may also be considered a particular organic form.

At its turn, this distinct rotor presents fissures to the passage of the divisor components, as well as presents a base to assemble sliding guides to act as movable connection of the divisors, whose number of divisors may vary in accordance with the engineering specifications of a specific application of this motor.

Also related to the divisors components, they present rectilinear profile, such as a stem, with bearings such as rings in theirs base, where this rectilinear body is assembled in rectilinear channels (pivoted guides), disposed on the body of the rotor component, being in its inferior end bearings are defined to allow the assemblage in the median region of the body of the main axis principal, crankshaft type. The center of the bearings of the divisors coincides with the center of the cylindrical cavity (jacket) and with the center of the main axis, crankshaft type, allowing the divisors freely rotate, keeping theirs stems in a condition of constant perpendicularity related to the cylindrical cavity (jacket) during the whole cycle of the rotor/divisors set.

With this constructive concept revealed, from the functional point of view the divisors pass to describe a movement of concentric rotation related to the cavity of the chamber, thus assuring that the free ends describe a condition of normal tangency in the complete outline of the internal cylindrical wall of the cavity during the turn of 360° of the rotor/divisors set, when these perform the phases of intake, compression, explosion/expansion and flow/exhaust.

Also considering the obtained functionality, we have the center of the distinct rotor orbits around the center of the jacket, performing translation movements (orbit whose center coincides with the center of the jacket and also with the primary center of the main axis, crankshaft type). Additionally, the rotor component also turns around its own axis. Its rotation center is coincident with the cam center of the main axis, crankshaft type. The translation (orbit) movement of the rotor is driven by the cam of the main axis and the rotation movement is a result of the interference of the satellite gear fixed to the rotor, defined in the same, with the stationary planetary gear fixed to a static component (anterior or posterior plate) or to another static component of the set.

In the inedited constructive concept revealed in this document, the synchronized combination of booth movements of the distinct rotor, translation and rotation, makes it deviates and brings near to the cylindrical face of the cavity (jacket), increasing and reducing the volume of the chambers, respectively and sequentially to each 90°-angle of the turn of the rotor, such turn resulting from the command of the planetary gear fixed to any static element of the set over the satellite gear fixed to the distinct rotor.

In this inedited constructive concept, we can see that each 90°-turn of the distinct rotor around its own axis the main axis, crankshaft type, is forced to rotate around its own axis in a 270°-angle, concluding that to each 360°-turn of the distinct rotor the main axis rotates around its own axis in a 1,080°-angle, i.e., 3 complete turns.

Also in this inedited constructive concept, we can see the three chambers sequentially define the four classical phases of an internal combustion engine, i.e.: when the rotor deviates from the jacket, the corresponding chamber to that position tends to increase its volume, and consequently the counter-clockwise movement of the rotor performs the phase of intake in the point coinciding to 180°, or 09h00 if we consider the dial as a clock. After this phase, the counter-clockwise movement of the rotor performs the phase of compression/explosion at 270° or 06h00; in the sequence, the counter-clockwise movement of the rotor performs the phase of expansion (phase motor) at 360°/0° or 03h00; and in the sequence the counter-clockwise movement of the rotor performs the phase of exhaust (flow) and restarts the phase of intake to this same chamber in reference at 90° or 12h00, sequentially occurring the same with the three chambers, when these will perform the four classical phases, in the same described angular positions, during a complete turn of the rotor around its own axis, when the same rotor performs three complete orbits, and consequently makes the main axis, crankshaft type, to perform three complete turns around its own center. To each set of these movements the engine performs a complete cycle, with three explosions, one in each chamber.

It is important to highlight that such cycle is only related to this revealed constructive concept, where we adopted, only for instance, a relation between the planetary and satellite gears of 1:1.5 number of teeth and three chambers, but not limited to this relation and/or to this number of chambers, since the conception of this inedited engine allows “n” relations between the planetary and satellite gears, simultaneously conjugated to “n” number of chambers, performing “n” complete cycles of explosion, to each complete 360°-turn of the rotor.

This inedited constructive concept, as well as its functionality, has a potential value when compared to the logic used in the conventional rotary engines, since it is possible the definition of “n” divisor components to the definition of “n” chambers of the cycle of intake, compression, explosion/expansion and flow and “n” cycles of these four complete phases to each complete turn of the rotor (to the Wankel engine only three chambers are defined, where its constructive concept does not allow variations of this number). This inedited constructive concept also allows parallel assemblage of engines, defining arrangements with several engine sets, driving a main axis, crankshaft type.

The petitioner also wants to highlight that the revealed constructive and functional concepts, object of claim, may be applied to all types of engine (two-stroke or four-stroke-cycle).

### FIGURES DESCRIPTION

In order to complement the current description, and to get a better understanding of the characteristics of the present demand of invention, a set of drawings is attached, where in an exemplified, but not limited, way a constructive concept and functionality of a “Wankel” rotary engine is represented indicating its deficient points, as well as a constructive concept of a form of realization of the rotary engine now claimed is revealed, where:

FIG. 1 is an illustrative representation of the Wankel rotary engine showing an interaction among the main movable components and the cavity of the static component, or jacket.

FIG. 2 is an amplified detailed representation of the contact point between the discreet sealing element, installed in the rotor edge and the jacket surface, to the Wankel rotary engine, indicating a condition of non-perpendicularity between these component parts.

FIG. 3 is an illustrative representation of the cycles of intake, compression, explosion/expansion and exhaustion, performed by the Wankel rotary engine, showing the variable oblique angles of contact formed between the sealing elements and the jacket surface in an 8-shape, during the complete cycle of the rotor, which significantly compromises the efficiency of the sealing between the chambers.

FIG. 4 is a perspective view showing the closed rotary engine, in one form of realization, highlighting its predominant cylindrical and compact profile.

FIG. 5 is a perspective view showing the internal constructive concept of the new rotary engine in one form of realization.

FIG. 6 is a perspective view showing the new rotary engine in one form of realization, without the posterior closing plate, without the main block and without the jacket, revealing its movable component parts and the planetary gear, these components forming the mechanism of the rotary engine now claimed.

FIG. 6.1 is an amplified detailed perspective view showing the interference between the planetary gears fixed to any static element of the new rotary engine, such as the posterior or anterior closing plates, with the satellite gear fixed to the rotor element.

FIG. 7 is a frontal view without the posterior closing plate, showing the new rotary engine in one form of realization, revealing its movable component parts that form the mechanism of the rotary engine now claimed.

FIG. 8 is an amplified detailed representation of the contact point between the sealing elements installed in the end of the divisors and the cylindrical surface of the cavity of the jacket to the new rotary engine in one form of realization, indicating an inedited condition of effective perpendicularity between these components during the whole functional cycle completed by the rotor.

FIG. 9 is an exploded frontal perspective view showing the new rotary engine in one form of realization, revealing all static and dynamic component parts that form the mechanism of the rotary engine now claimed.

FIG. 10 is an exploded posterior perspective view showing the rotor component and its closing axial component/bearing base and its fixation elements, also showing in a first plan the satellite gear fixed to this rotor, in a specific form of realization.

FIG. 11 is an exploded anterior perspective view showing the rotor component and its closing axial component/bearing base and its fixation elements in a specific form of realization.

FIG. 12 is a perspective view of the divisor components of chambers of the new rotary engine assembled in a specific form of realization.

FIG. 13 is an exploded perspective view showing the divisors of chambers and its pivoted sliding guides of the new rotary engine in a specific form of realization.

FIG. 14 is an illustrative representation of the functional cycle performed by one of the three chambers to a form of realization of the new rotary engine now claimed, in the final phase of maximal intake.

FIG. 14.1 is an amplified detailed view of the position of the reference divisor related to the axial wall of the fissure defined in the body of the rotor component during the initial kinematics phase described by the rotary engine now claimed, also highlighting the normal position of the divisor element related to the cylindrical cavity of the block (jacket).

FIG. 15 is an illustrative representation of the functional cycle performed to a form of realization of the new rotary engine now claimed in the medium phase of compression.

FIG. 15.1 is an amplified detailed representation of the position of the reference divisor related to the axial wall of the fissure defined in the body of the rotor component, during compression phase of the kinematics described by the rotary engine now claimed, also highlighting the normal position of the divisor element related to the cavity of the block (jacket).

FIG. 16 is an illustrative representation of the functional cycle performed by one of the three chambers to a form of realization of the new rotary engine now claimed in the phase of maximal compression and explosion.

FIG. 16.1 is an amplified detailed representation of the position of the reference divisor related to the axial wall of the fissure defined in the body of the rotor component during the kinematics phase of the explosion cycle, described by the rotary engine now claimed, also highlighting the normal position of the divisor element related to the cavity of the block (jacket).

FIG. 17 is an illustrative representation of the functional cycle performed by one of the three chambers to a form of realization of the new rotary engine now claimed in the medium phase of expansion.

FIG. 17.1 is an amplified detailed representation of the position of the reference divisor related to the axial wall of the fissure defined in the body of the rotor component during the medium phase of expansion of the kinematics described by the rotary engine now claimed, also highlighting the normal position of the divisor element related to the cavity of the block (jacket).

FIG. 18 is an illustrative representation of the functional cycle performed by one of the three chambers to a form of realization of the new rotary engine now claimed in the phase of maximal expansion and initial phase of depletion, when the respective chamber starts its depletion.

FIG. 18.1 is an amplified detailed representation of the position of the reference divisor related to the axial wall of the fissure defined in the body of the rotor component, when in this phase the respective chamber exhausts during the kinematics described by the rotary engine now claimed, also highlighting the normal position of the divisor element related to the cavity of the block (jacket).

FIG. 19 is an illustrative representation of the functional cycle performed by one of the three chambers to a form of realization of the new rotary engine now claimed, in the final phase of depletion, when the respective chamber starts its intake.

FIG. 19.1 is an amplified detailed representation of the position of the reference divisor related to the axial wall of the fissure defined in the body of the rotor component, when in this phase the respective chamber is exhausting during the kinematics described by the rotary engine now claimed, also highlighting the normal position of the divisor element related to the cavity of the block (jacket).

### DETAILED DESCRIPTION

The following detailed description should be read and interpreted with the attached drawings, merely illustrative ones, representing some forms de realization of the new rotary engine, not limiting the scope of this invention, which is only limited in the Claims section.

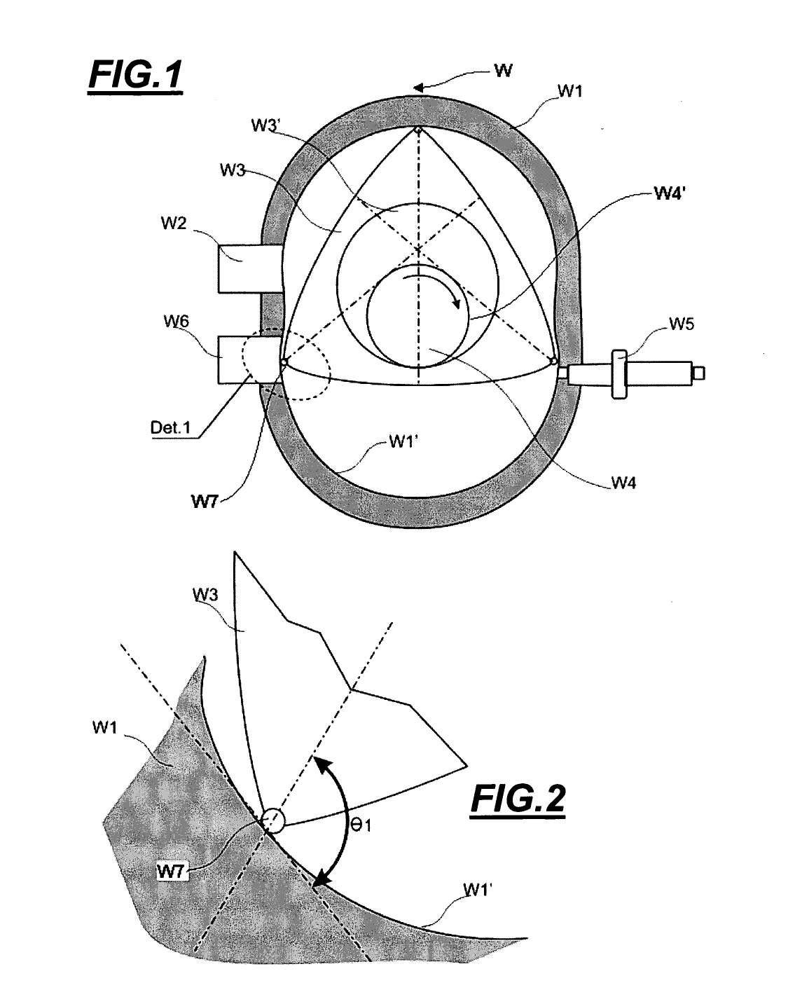

In accordance with the illustrative drawings of the present demand of patent of invention the petitioner believes it is important to get a better understanding of the innovation to present the constructive concept of a Wankel rotary engine, which is made in FIGS. 1, 2 and 3, where its classical constructive concept is specially revealed in FIG. 1, where the Wankel engine (W) is composed by a unique jacket (W1), which describes a cavity (W1′) with an approximate 8-shape, which presents in its body an access (W2) to air/combustible mixture and an access (W6) to gases exhaust, as well as a spark plug (W5). In its interior is assembled a triangular rotor (W3) that presents internal cavity (W3′), mainly a toothed cavity (the teeth are not represented), which interacts with the static toothed segment (w4′), where the teeth are not represented, of a rotation axis (W4), crankshaft type. Additionally, in the edges of the triangular rotor (W3) sealing elements (W7) are assembled.

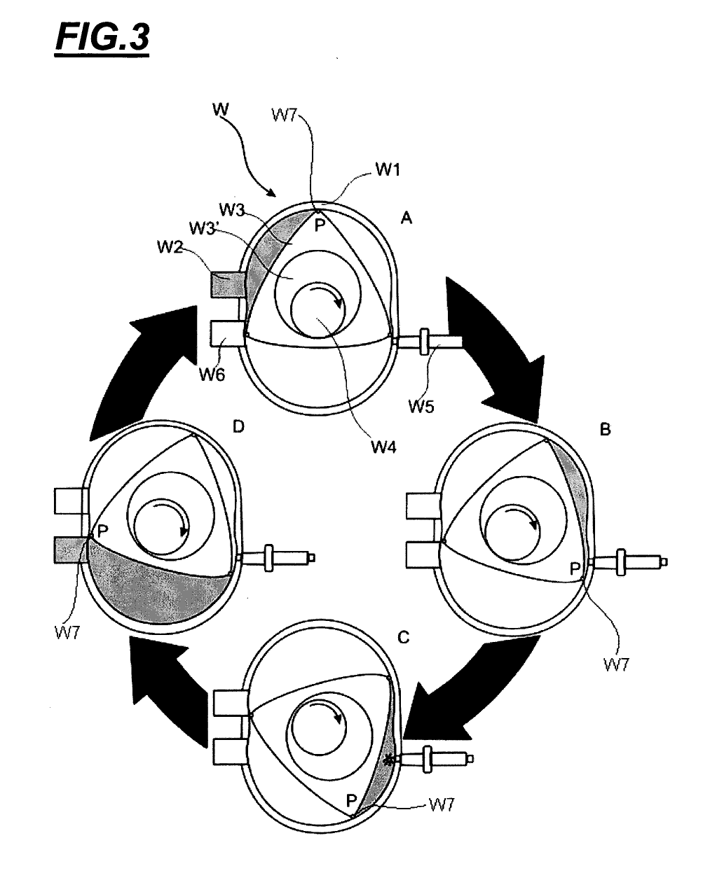

The deficient aspect of the constructive concept of this Wankel rotary engine (W) is the fact that the triangular rotor (W3), when describing a movement of eccentric turn related to the rotation axis (W4), makes the tangency between the sealing element (W7) and the wall of the cavity (W1′), or jacket, describes an angle (Θ1) that is not perpendicular in practically the entire cycle, where this angle is oblique and variable from positive to negative (see FIG. 3, where the positions of the sealing element (W7) are highlighted), since this sealing element (W7) makes the tangency, describing all the outline of the jacket cavity (W1′), leading the sealing element to an inadequate design to perform the internal cleaning of the cavity, also making deficient the necessary tightness between the chambers, which is fundamental to the engine presents efficiency, durability and reliability.

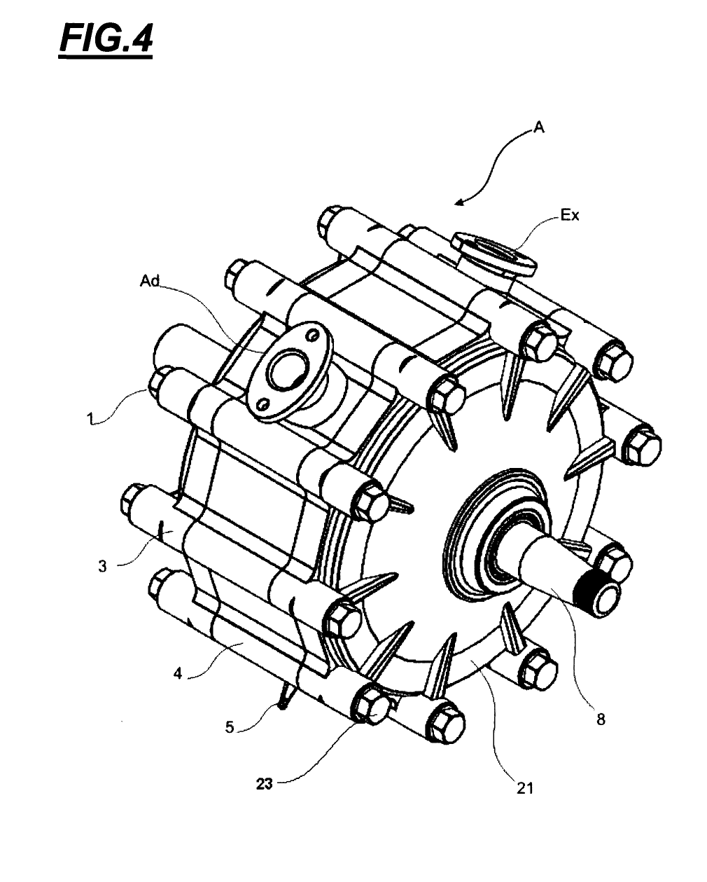

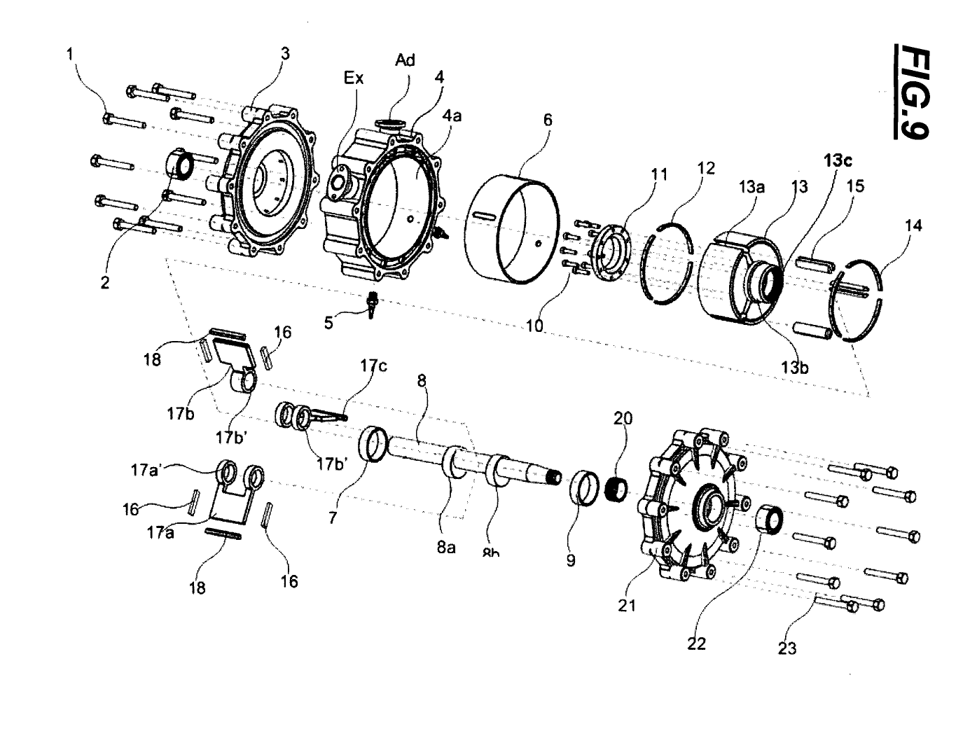

After duly explained the constructive concept and also the functional concept of the Wankel rotary engine (W), the petitioner starts detailing the inedited internal combustion engine of rotary type as illustrated in FIGS. 4, 5, 6, 7 and 8, applying the inedited concepts, constructive and functional, revealed and claimed in this document.

In a first moment, we can verify the distinct shape of this engine, highlighted in FIG. 4, where the rotary engine (A) presents in a preferred form of realization an external shape of a typically cylindrical solid, which is derived from the perfect cylindrical shape defined by the jacket component (6), which will be detailed in the next paragraphs.

At its turn this external shape is a result of the assemblage of the anterior plate component (3), which has the function of providing anterior closing of the main block component (4), this one with the function of providing housing to the components, static and dynamic, of functional natures, which form the inedited mechanism of the rotary engine (A). Additionally, this main block (4) receives in its frontal part the assemblage of a posterior plate component (21), which has the function of providing posterior closing of this main block (4).

The main block (4) presents a constructive concept, which in its superior part is defined: the intake nozzle (Ad) and the depletion nozzle (Ex), which has as the function of receiving the combustible/comburent mixture and to exhaust the burned gases, respectively. At its turn, in the inferior part of this main block (4) is defined a pair of spark plugs (5), which has the function of provoking sparks to ignite the mixture during the explosion phase of the functional cycle of the engine (A). Finally, the main block (4) has a cylindrical cavity (4a), which is adequate for the assemblage of the rotor component (13) and of the other dynamic components, such as: divisors, pivoted guides, sealing elements between chambers, axial seals, etc.

The union between the main block components (4) and the anterior plate (3) is done through a plurality of fixation elements (1), such as hexagonal head bolts. Similarly, the union between the components, main block (4) and posterior plate (21), is done through the use of a plurality of fixation elements (23), such as hexagonal head bolts.

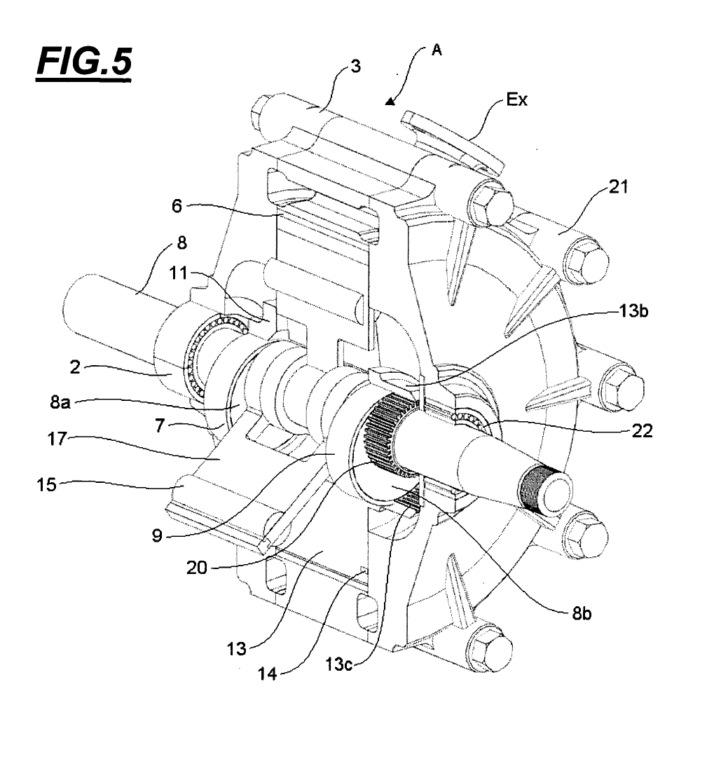

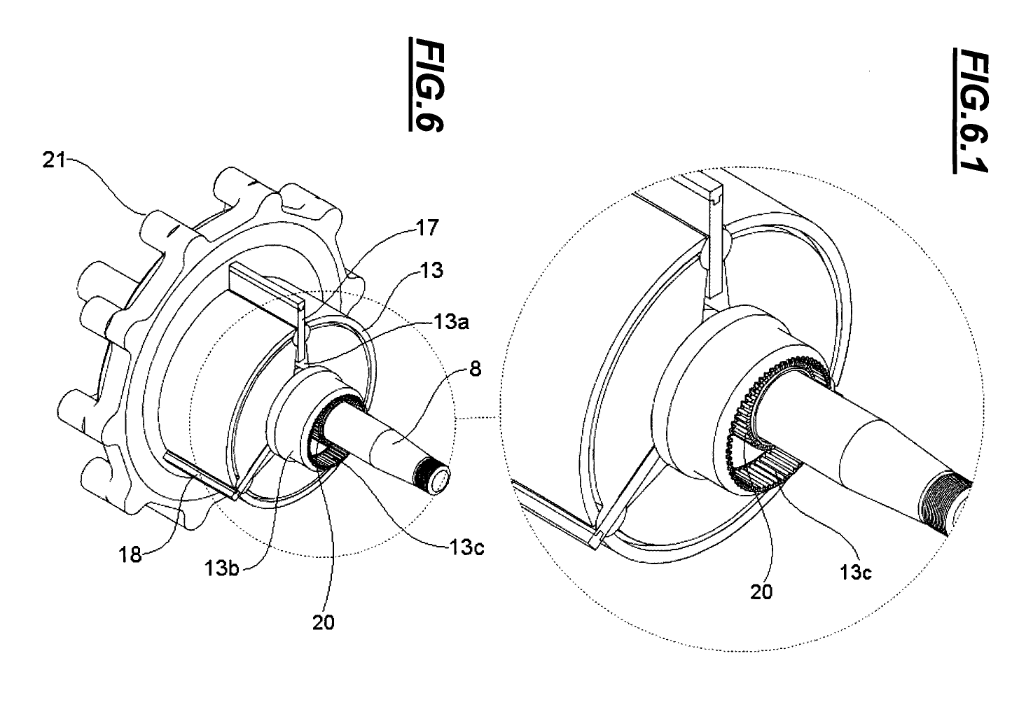

In FIG. 5 it is possible to see that the posterior end of the main axis component (8) passes through the posterior plate (21), passage structured by the assemblage of a fixed posterior bearing component (22). Similarly, the anterior end of this engine axis (8) passes through the anterior plate (3), where this passage is also structured by the assemblage of a fixed anterior bearing component (2).

The main axis component (8) is a component of crankshaft type, formed by axis and a pair of cams, (18a) and (18b), where is assembled the rotor (13), which is also assembled inside the rotary engine (A) in a stabilized way through an anterior bearing component (7) and a posterior bearing component (9), where the rotor (13) is coupled in a way to have a free turn over the cams, (8a) and (8b), through the referred bearings, (7) and (9).

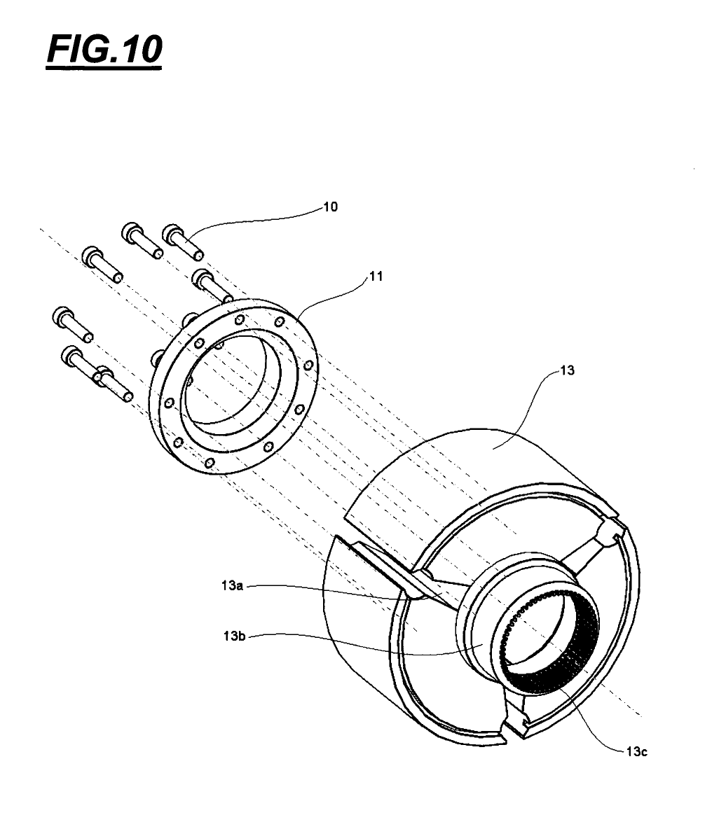

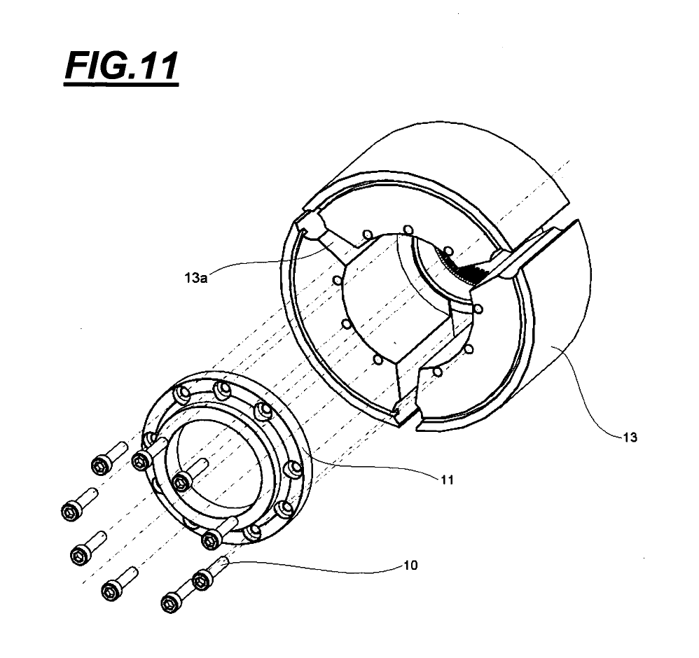

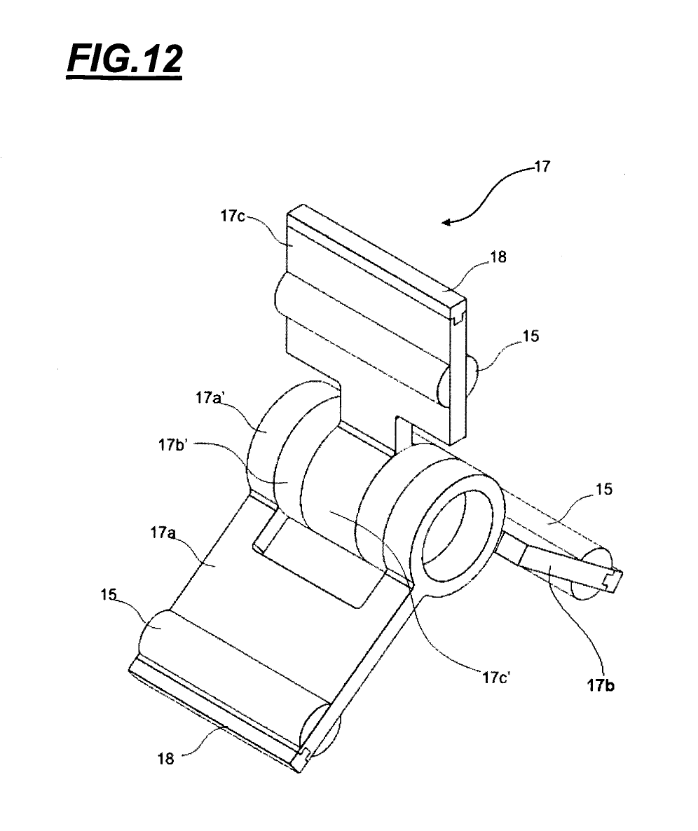

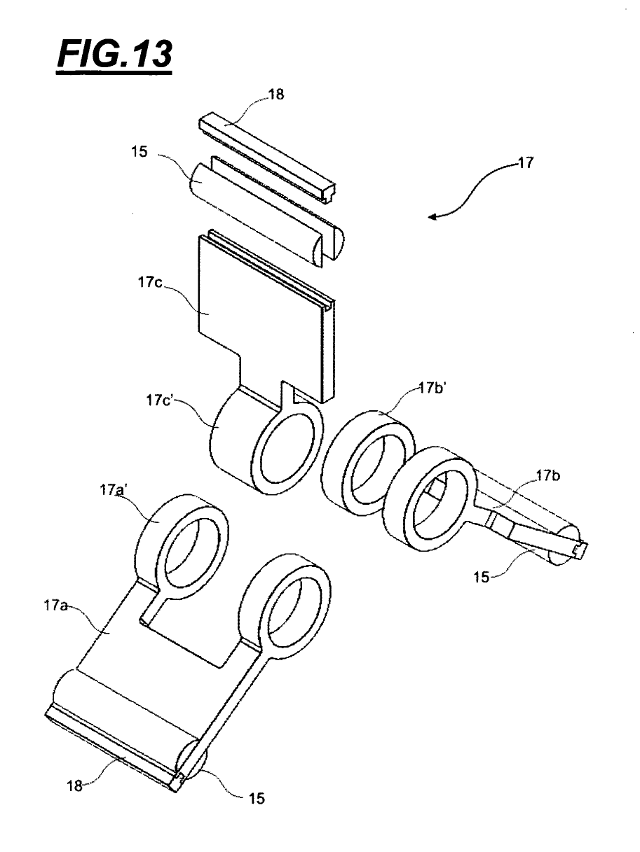

At its turn the rotor component (13) presents a distinct constructive concept, which is showed in details in FIGS. 10 and 11, being based on a cylindrical solid. Its constructive concept presents at least three transversal fissures of polygonal profile to the passage of the divisors through the referred rotor.

In the external part this trapezoidal profile suffers a transition to a transversal cylindrical shape in which pairs of pivoted guides in a sliding and oscillating way perfectly fit, such as parts of a cylinder of linear sliding support of the divisor, making possible the mechanical assembly of perfect dynamic operation of the set of rotor/divisors/pivoted sliding guides of the divisors. The referred set, rotor/divisors/pivoted sliding guides of the divisors, perfectly fits the internal part of the jacket component (6). In the rotor component (13) is also defined, in the anterior part, an anterior closing plate (11), such as a cover, which also serves as basis to the assembly of the anterior bearing (7) of the rotor (13). The divisors are disposed in a radial way among them. The rotor component (13) has as a reference point the neck (13b), whose interior receives a planetary gear element (13c), fixed to it, which has as function to assure the rotation movement of the rotor (13) around its own axis, whose rotation axis coincides with the center of the cams (8a) and (8b) of the main axis (8). The rotation movements of the rotor around its own axis, and the orbital movement (translation) of it, are combined, synchronized and assured by the interference of the planetary gear (13c) with a stationary satellite gear (20) and by the translation movement of the cams (8a) and (8b), where the center of the rotor through the bearings (7) and (9) is coupled. Such coupling makes both components, rotor (13) and cam (8a) and (8b), describe combined orbits, whose orbital center coincides with the center of the main axis (8).

The rotor (13) also receives in its anterior part an assembly of an axial seal (12), mainly an anterior axial seal of the rotor (13), and additionally to this, receives superposed a complementary component (11), mainly a cover-type complement of the rotor and bearing base, fixed through a plurality of fixation elements (10). Similarly, but in its posterior part, the rotor (13) receives an assembly of a second axial seal (14), mainly a posterior axial seal of the rotor (13).

Additionally, the polygonal profile of each fissure of the rotor (13) is described by an initial trapezoidal formation, whose function is to receive the corresponding divisor set (17). In its extreme part, each trapezoidal profile passes by a transition to a cylindrical form, where in the transition region of each fissure (13a) the pivoted sliding guides (15) of the divisor set (17) are accommodated in a way that the divisors (17a), (17b) and (17c) of this referred set (17) may follow all movements of the rotor (13) without interferences.

In the revealed form of realization we have that the divisor set (17) is physically defined by three divisor components (17a), (17b) and (17c), which are assembled with ring-like elements (17a′), (17b′) and (17c′), respectively, disposed in a parallel way. The divisor set (17) is assembled in the median region of the body of the main axis (8) delimited at its turn by the cams (8a) and (8b), respectively. At its turn, in the end of each divisor component (17), a radial seal component (18) is provided, whose function is to optimize the sealing between the chambers during the kinematics of movements, described by the end of each component of the divisor set (17) and its radial seals (18) related to the internal wall of the jacket component (6). Alternatively, the petitioner also provides the assemblage of a pair of axial seals (16) disposed in an axial form to each component of the divisor set (17).

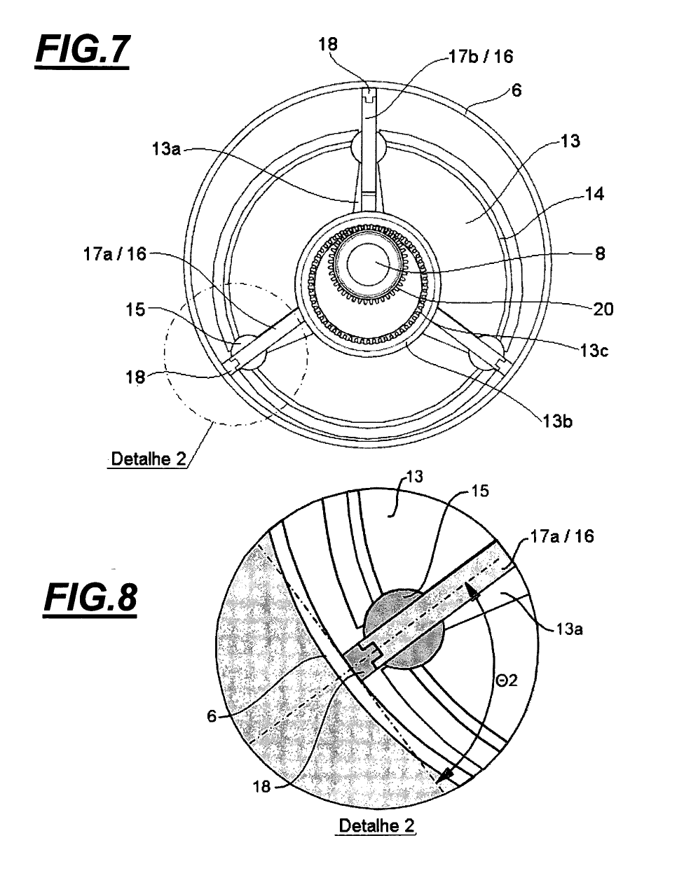

In the external part of each component of the divisor set (17), a set composed of pivoted guides (15) of connection of the divisors set (17) with the rotor (13) is assembled. These pivoted guides (15) assure the kinematics stability described by the divisor set (17) inside the fissures (13a) of the rotor (13). The referred pivoted guides (15) also assure the correct placement of the divisors (17) related to the rotor component (13) during the entire cycle of this rotor (13), when each pair of subsequent divisors associated to the rotor (13) forms one chamber, which is comprised among this pair of subsequent divisors, the sector of the rotor (13) defined between this pair of subsequent divisors and the sector of the jacket (6), also defined by this pair of subsequent divisors during the entire functional cycle of the engine (A), such as showed in FIG. 7, when the engine (A) performs the classical phases of an internal combustion engine.

Applied functional kinematics: the kinematics obtained from the rotary engine (A) describes the following functional phases:

1^{st}) Maximal intake;

2^{nd}) Compression;

3^{rd}) Explosion;

4^{th}) Expansion;

5^{th}) Depletion; and

6^{th}) Final and initial flow of intake.

The kinematics described by the rotary engine now claimed starts from the action of the engine axis (8), which by being a piece of crankshaft type, leads the rotor component (13) to describe an orbital movement around the internal diameter of the jacket (6) and by the action of the stationary planetary gear (20) over the satellite gear fixed to the rotor (13c), leading the rotor (13) to a rotation movement around its own center, this center coincident with the center of the cams (8a) and (8b) of the main axis (8) in all phases of the functional cycle of the rotary engine (A). The synchronized combination of these movements makes the chambers, formed between the rotor (13), divisor set (17) and jacket (6), sequentially describe the phases of the mentioned kinematics, being these phases characterize the classical functional cycle of the internal combustion engines (two- and four-stroke-cycle).

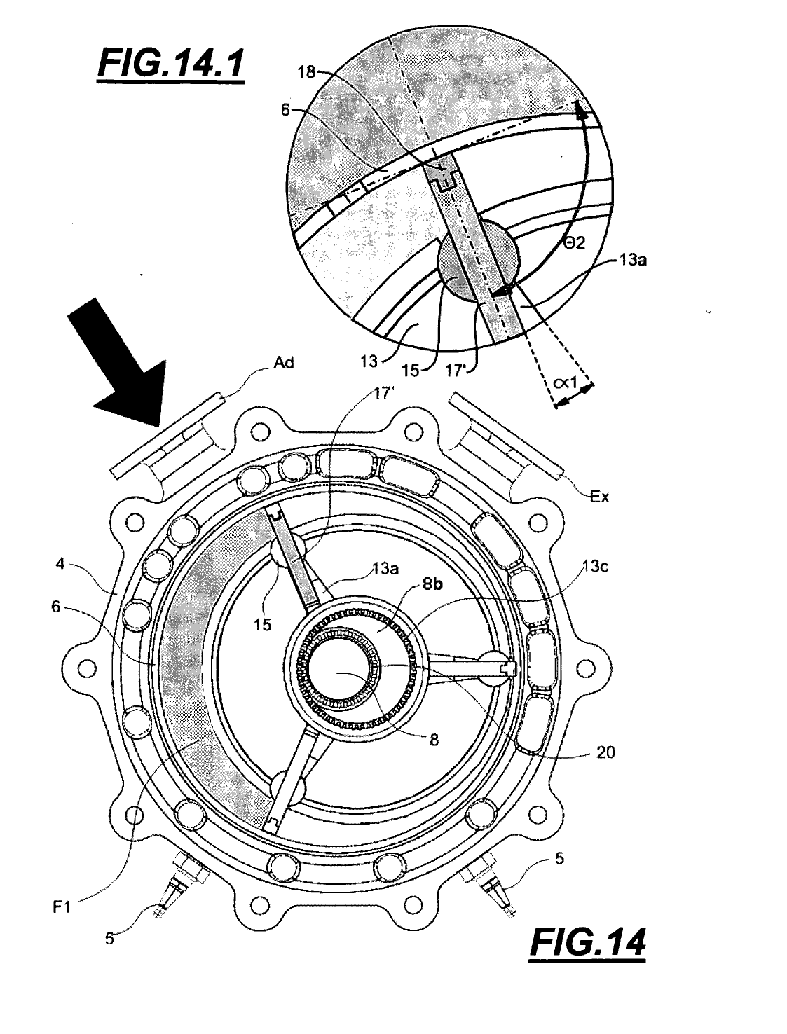

To a better understanding of the functional cycle of the new rotary engine (A), this cycle is illustrated in the FIGS. 14, 15, 16, 17 and 18, respectively, where the following phases are described:

1^{st}) Initial phase of maximal intake: in this phase the combustible/comburent mixture is admitted through the intake nozzle (Ad), entering in the chamber (F1) comprised between the components rotor (13), jacket (6) and two subsequent divisors (17). When the rotor (13) is deviated from the internal cylindrical face of the jacket (6), this chamber (F1) increases its volume in a way it is filled with the mixture, such as illustrated in FIG. 14.

The claimed innovation may be translated by the position of the reference divisor (17′), primarily related to the internal surface of the jacket (6), which describes a permanent perpendicular angle (Θ2) equal to 90°, during a 360°-turn of the reference divisor inside the jacket (6). At its turn it is possible to verify that to keep this perpendicularity condition this reference divisor (17′) is assembled by its rings, the median part of the main axis (8), in a way to freely rotate around this one, being its rotation center coincident with the center of this main axis (8), being also the rotation center of the main axis (8) coincident with the center of the jacket (6). It may be seen that the reference divisor (17) must axially displace inside the fissure (13a), where during this initial phase it makes the tangency of one of the walls of this fissure, forming an angle (α₁) between this reference divisor (17′) and the opposed wall of the non-tangency fissure (13a), as showed in the amplified detail in FIG. 14.1, where it is possible to see that the reference divisor (17′) follows the displacement of the rotor (13) and is kept in a constant normal position (Θ2) equal to 90° related to the internal wall of the jacket (6), during the movements of translation and rotation of the rotor (13), being that the positions of the reference divisor (17′) related to the rotor (13) are assured through a sliding/oscillating connection of the pivoted component (15).

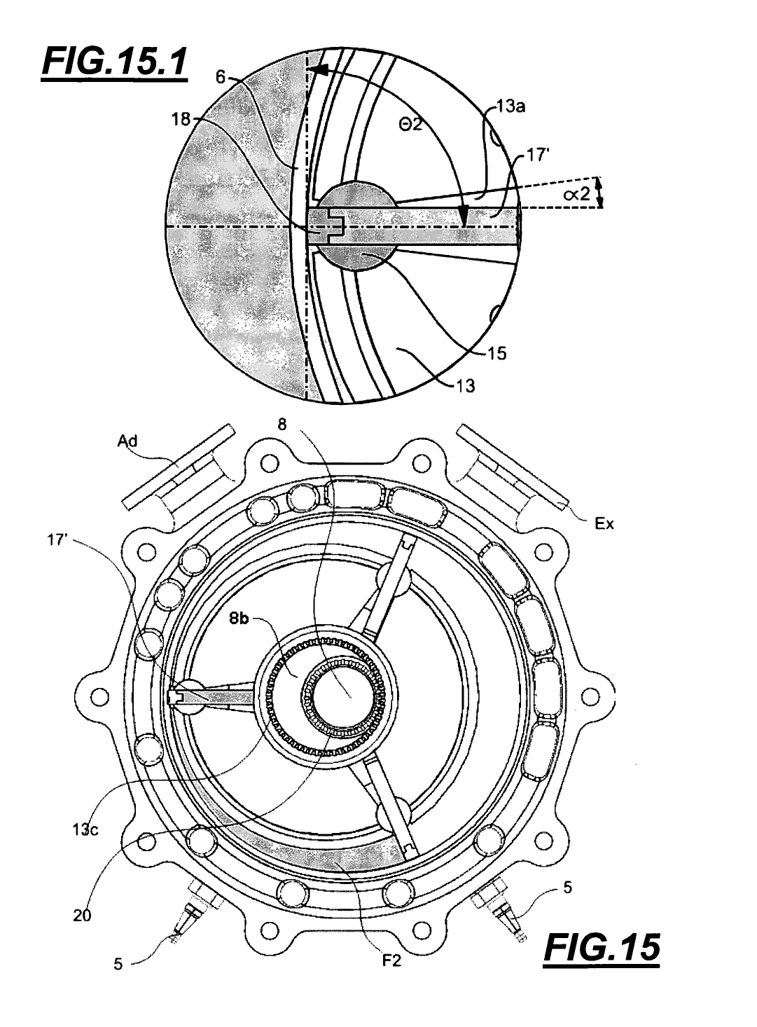

2^{nd}) Phase of compression: in this phase a combustible/comburent mixture, admitted in the intake nozzle (Ad), is progressively compressed by the approximation of the external cylindrical face of the rotor (13), comprised between two subsequent divisors (17), with an internal cylindrical face of the jacket (6), to the limit point of the formation of a chamber (F2), with reduced volume related to the volume of this phase of maximal intake (F1), highlighting the inventive aspect when it is kept the perpendicular angle (Θ2) equal to 90° between the reference divisor (17′) and the internal surface of the jacket (6), such as showed in FIG. 15. We can also see that the reference divisor (17′) follows the displacement of the rotor (13) and is kept in a normal constant position (Θ2) equal to 90° related to the internal wall of the jacket (6) during the translation and rotation movements of the rotor (13), being the positions of the reference divisor (17′) related to the rotor (13) are assured through a sliding/oscillating connection of the pivoted component (15).

At its turn it is possible to see that to conveniently follow the movements of the rotor (13) inside the jacket (6), this reference divisor (17′) must axially displace inside the fissure (13a) of the rotor (13), where in this compression phase it particularly is in the medium point between the two walls of this fissure, describing an angle (α₂) between this reference divisor (17′) and the walls of the fissure (13a), such as illustrated in the amplified detail in FIG. 15.1.

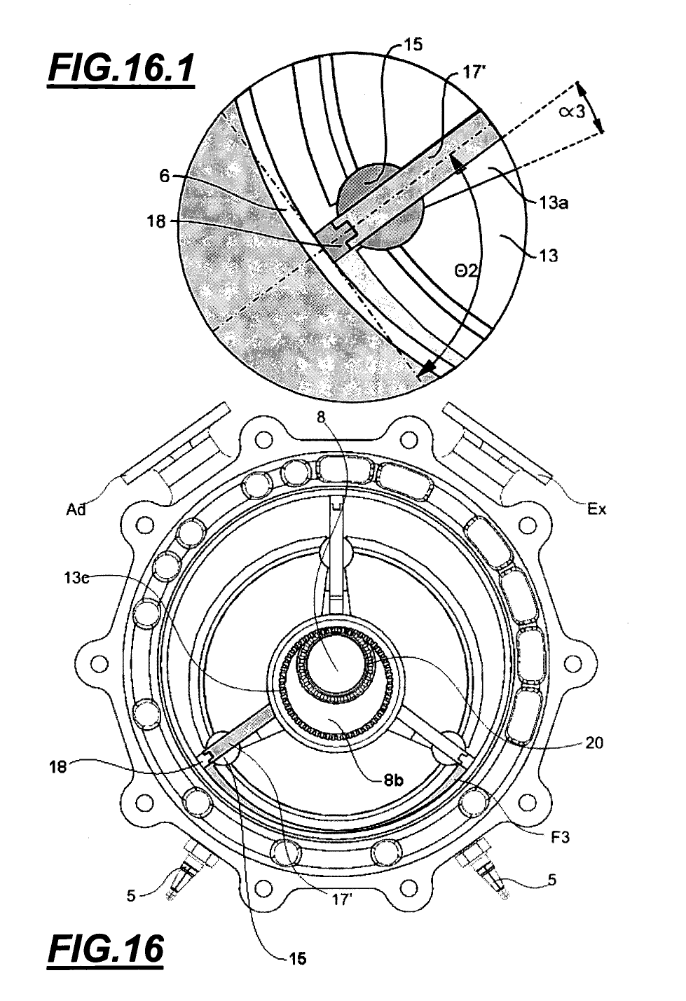

3^{rd}) Phase of explosion: in this phase, the combustible/comburent mixture is progressively compressed until the limit of the formation of a forked chamber (F3), where the volume of this chamber is extremely reduced, where the explosion of the mixture occurs through the generation of sparks by the spark plug (5) or by self-combustion, where we again highlight the inventive aspect when the perpendicular angle (Θ2) is kept equal to 90° between the reference divisor (17′) and the internal surface of the jacket (6), such as showed in FIG. 16. We can also verify that mainly the reference divisor (17′) follows the displacement of the rotor (13) and is kept in a constant normal position (Θ2) equal to 90° related to the internal wall of the jacket (6) during the translation and rotation movements of the rotor (13), being the positions of the reference divisor (17′) related to the rotor (13) are assured through a sliding/oscillating connection of the pivoted component (15).

At its turn it is possible to verify that to conveniently follow the rotor (13) movements inside the jacket (6), this reference divisor (17′) must axially displace inside the fissure (13a) of the rotor (13), where in this particular phase of explosion the reference divisor (17′) makes the tangency of one of the walls of the fissure, forming an angle (α₃) between this divisor and the opposed wall of the non-tangency fissure (13a), such as showed in the amplified detail in FIG. 16.1.

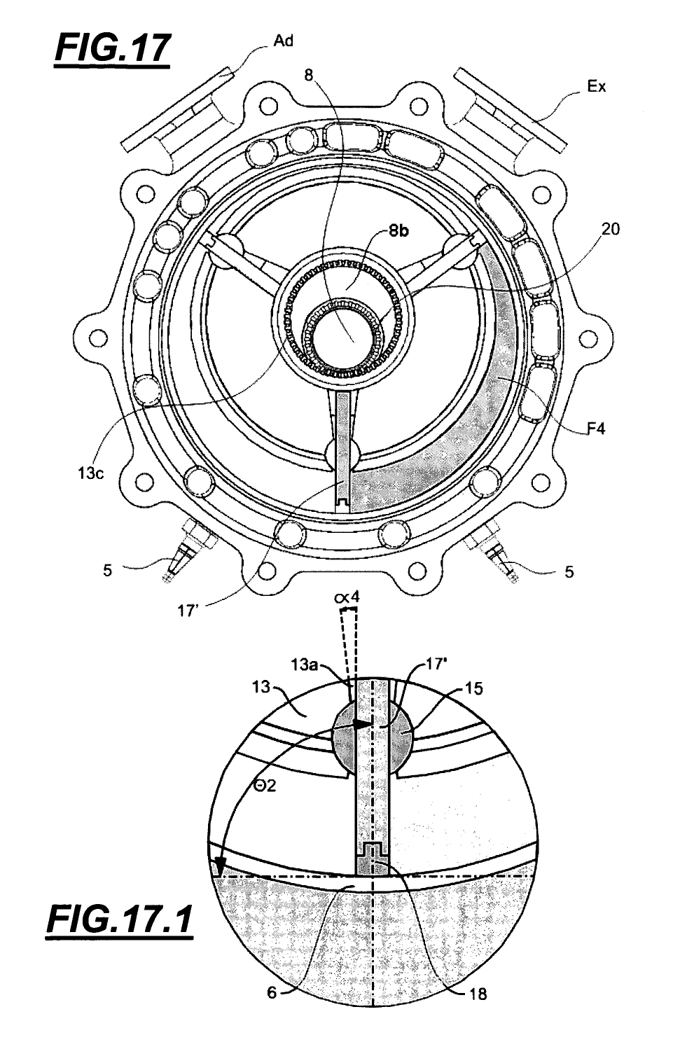

4^{th}) Phase of expansion: in this phase, with the previous action of the explosion of the combustible/comburent mixture and with the continuous displacement of the rotor and divisors set (17), a formation of an expansion chamber (F4) occurs between this set and the jacket (6), when in this phase the rotor (13) receives an impulse from the expansion of the gas under high pressure, being forced to be displaced, transferring the force of this impulse to the cams (8a) and (8b) of the main axis (8), obligating this main axis to rotate around its own center, creating the engine moment of the cycle. During this cycle the volume of this chamber passes from extremely compressed to extremely amplified, as a consequence of the displacement of the rotor (13) and divisors set, which form the referred chamber. Again, we must highlight the inventive aspect, when the perpendicular angle (Θ2) is kept equal to 90° between the reference divisor (17′) and the internal surface of the jacket (6), such as showed in FIG. 17, which illustrates the chamber (F4) during the expansion phase.

At its turn it is possible to verify that to conveniently follow the movements of the rotor (13) inside the jacket (6), this reference divisor (17′) must axially displace inside the fissure (13a), where in this particular phase of expansion it is in the medium point between the two walls of the fissure, forming an angle (α₄) between this reference divisor (17′) and the walls of the fissure (13a), such as showed in the amplified detail in FIG. 17.1. We can mainly see that the reference divisor (17′) follows the displacement of the rotor (13) and is kept in a constant normal position (Θ2) equal to 90° related to the internal wall of the jacket (6) during the movements of translation and rotation of the rotor (13), being the positions of the reference divisor (17′) related to the rotor (13) are assured through a sliding/oscillating connection of the pivoted component (15).

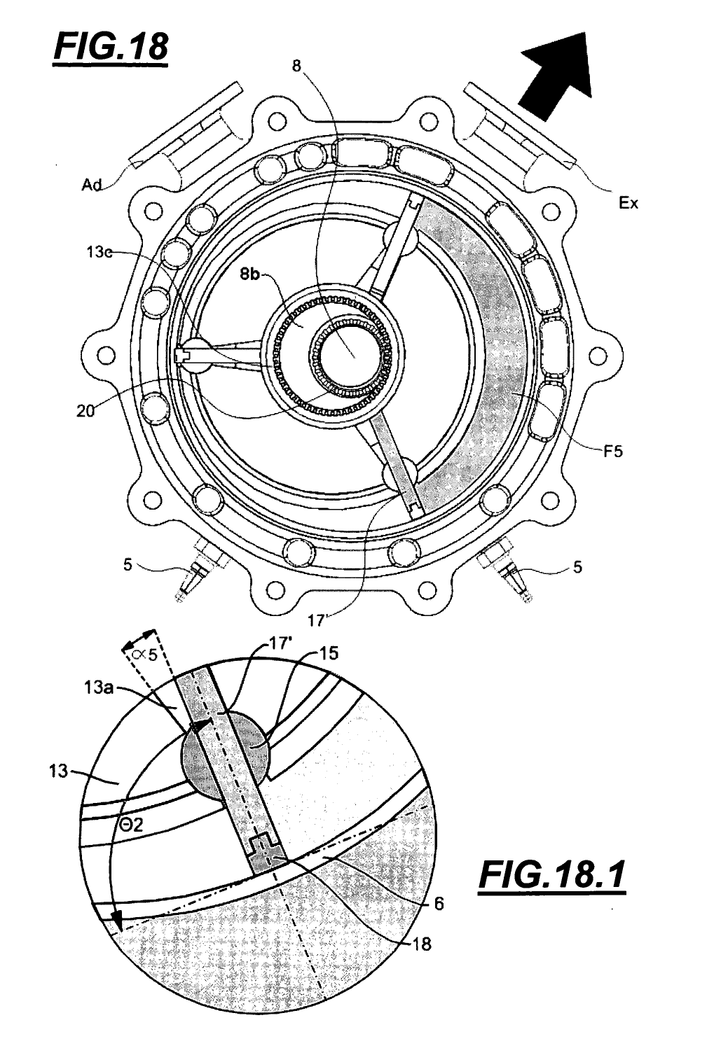

5^{th}) Phase of depletion: in this phase the burned gas, in the final phase of expansion, starts to be exhausted through a depletion nozzle (Ex) at the limit point of formation of a chamber (F5) in maximal expansion, such as showed in FIG. 18, where we also highlight the inventive aspect, when the perpendicular angle)(Θ2=90°) is kept between the reference divisor (17′) and the internal surface of the jacket (6), such as showed in amplified details in FIG. 18.1.

At its turn it is possible to verify that to conveniently follow the movements of the rotor (13) inside the jacket (6), this reference divisor (17′) must axially displace inside the fissure (13a), where in this phase of depletion it particularly makes the tangency of one of the walls of this fissure, forming an angle (α₅) between this divisor and the opposed wall of the non-tangency fissure (13a), such as showed in amplified details in FIG. 18.1. We can mainly verify that the reference divisor (17′) follows the displacement of the rotor (13) and is kept in a constant normal position (Θ2) equal to 90° related to the internal wall of the jacket (6) during the movements of translation and rotation of the rotor (13), being the positions of the reference divisor (17′) related to the rotor (13) are assured through a sliding/oscillating connection of the pivoted component (15).

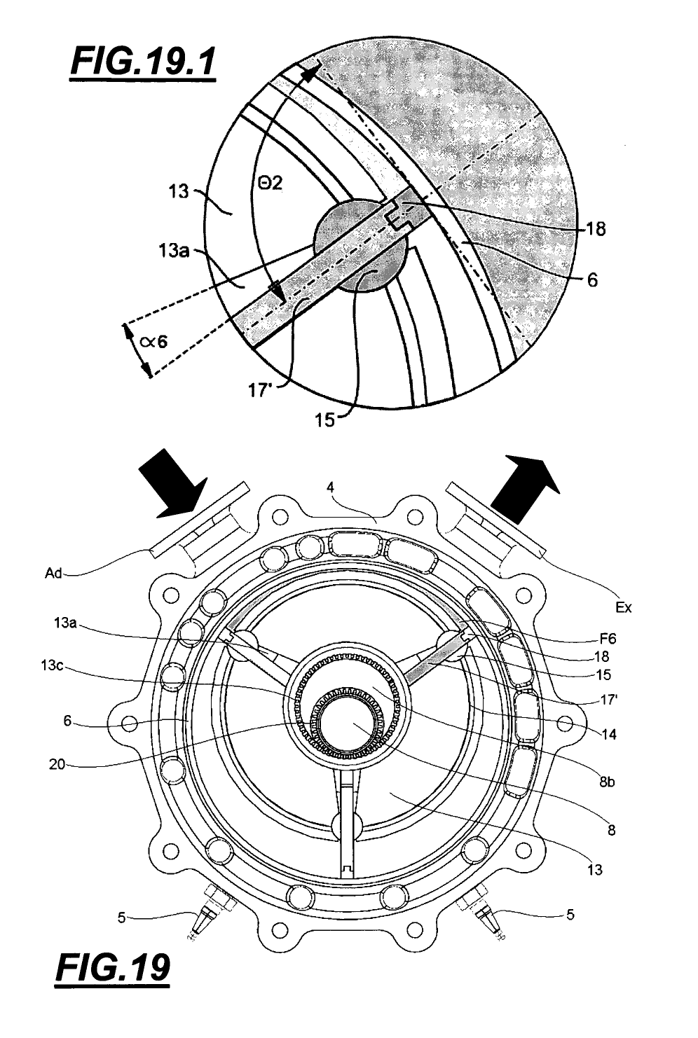

6^{th}) Final phase of depletion and initial phase of a new cycle: in this phase the two subsequent divisors of the set (17), in a combined movement with the rotor (13), rotate until the limit point of a forked chamber (F6), where the volume of this chamber is again extremely reduced, such as showed in FIG. 19, when the gas from the burned mixture is totally discharged through the nozzle (Ex), completing the cycle performed by this referred chamber, starting the realization of a new cycle to the referred chamber. We must again highlight the inventive aspect when a perpendicular angle (Θ2) is kept equal to 90° between the reference divisor (17′) and the internal surface of the jacket (6), such as showed in FIG. 19.1. We can also see that during the movements of translation and rotation of the rotor (13), the positions of the reference divisor (17′) related to the rotor (13) are assured through a sliding/oscillating connection of the pivoted component (15).

The petitioner also highlights that as a part of the claimed innovation the kinematics described by the angular movement (a) of the reference divisor (17′) related to the internal walls of the fissure (13a) of the rotor (13) occurs due to the combination of the movement described by the main axis (8), which by being a crankshaft-type piece makes the cam describes an orbital movement, whose orbit center coincides with the center of the main axis (8), forcing and consequently driving the rotor (13) to follow this orbital movement, being the rotation movement of the rotor (13) is driven and resulting from the interference of the fixed planetary gear component (20) with the satellite gear (13c) fixed to the rotor (13). The petitioner also highlights that the divisor components (17) follow the movements of translation and rotation of the rotor (13) in its entire route during its complete 360°-cycle, effectively keeping the radial tangency of each divisor of the divisors set (17) normal to the internal cylindrical surface of the jacket (6), i.e., (Θ2=90°) during this entire 360°-cycle, being this follow-up is made possible by the format of the sliding/pivoted guides coupling (15) between the rotor (13) and divisors set (17), whose couplings allow the free and enough movement between these components, rotor (13) and divisors set (17).

The petitioner also highlights that as reference divisor (17′) we must understand all divisors (17a), (17b) and (17c) that are highlighted in FIGS. 14, 14.1, 15, 15.1, 16, 16.1, 17, 17.1, 18 and 18.1 to a better understanding of this part of the document, where the divisors set (17a), (17b) and (17c) simultaneously describes the circular movements, whose rotation center is coincident with the center of the cylindrical jacket (6), assuring the maintenance of the perpendicular angle (Θ2=90°) of its end always constant related to the internal surface of the jacket (6), and also describes angular movements (α₁), (α₂), (α₃), (α₄) and (α₅) related to the walls of the fissures (13a), assuring the free and enough relative movement between the rotor (13) and divisors set (17) components.

The form of realization of the rotary engine (A) described in this document is only provided as an example. Changes, modifications and variations of this basic conception may be performed to particular forms, mainly when the divisors set of the chambers is formed by two, three, four, five, six or several reference divisors components (17′), where the rotor component (13) may present all kind of geometric or organic format, where these constructive variants must be performed by skilled technicians without diverging from the scope of the patent of invention, which is exclusively defined in the Claims section.

The inedited conception of this rotary engine (A), now claimed and exemplified in the proposed form of realization, also allows to define a plurality of arrangements that define a plurality of chambers associated to a plurality of divisors (17′), having one or a plurality of rotors (13), with one or a plurality of coherent relations between planetary (13c) and satellite gears (20), defining one or a plurality of motor cycles, two- or four-stroke, to each complete turn of the rotor and one or a plurality of rotors (13) coupled or not in a parallel way, driving one or a plurality of main axis (8), directly coupled among themselves or not.

We can see for all described and illustrated is that the “Internal Combustion Engine, Rotary Engine Type, with Distinct Conception, Durability and Performance, Applied to all Types of Vehicle or Industrial Equipment” now claimed accomplishes the rules that govern the patent of invention according to the Law of Industrial Property, deserving as consequence the respective privilege.

1) “Internal Combustion Engine, Rotary Engine Type, with Distinct Conception, Durability and Performance, Applied to all Types of Vehicle or Industrial Equipment”, being this engine (A) formed by a housing specifically defined by a main block (4), which is composed in its superior part by an intake nozzle (Ad) and a depletion nozzle (Ex) and in its inferior part by spark plugs (5), where this main block (4) is closed in its anterior part by an anterior plate (3), fixed through a plurality of fixation elements (1), such as hexagonal head bolts, being the frontal part of this main block (4) is closed by a posterior plate (21) through a plurality of fixation elements (23), such as hexagonal head bolts, being this main block (4) is characterized by having a cylindrical cavity (4a) that receives the assembly of a jacket component (6), which is also perfectly cylindrical, where it receives the assembly of a set of components, such as rotor component (13) in the form of a cylindrical solid, containing in its anterior and posterior ends an axial seal set (12) and an axial seal set axial (14), respectively, where to the rotor (13) is superposed a complementary component (11), such as a rotor cover and bearing base of connection with the anterior cam (8a), fixed through a plurality of fixation elements (10), such as hexagonal head bolts, being the rotor (13) presents fissures (3a), with polygonal profile composed by an initial trapezoidal conformation followed by a transition to the cylindrical form, which have the sliding guide elements (15) of connection of the divisors (17), with the rotor (13), where these fissures (13a) are disposed in a radial form among themselves in this rotor (13), also having this rotor (13) as reference point the neck (13b), whose interior receives a satellite gear element (13c) fixed to this one; being the fissures (13a) of the rotor (13) receive the assembly of the divisor set (17), which is composed by at least two divisor components (17a), (17b) and (17c), which fit among themselves in an intercalated form among the ring-like elements (17a′), (17b′) and (17c′), respectively, being each divisor component receives an assembly of a radial seal component (18), which makes the tangency of the internal wall of the jacket component (6), forming the radial sealing among these divisors (17a), (17b) and (17c) and the referred jacket (6), and also receives a set of axial seals (16) in the lateral faces, which makes the tangency of the plates of anterior closing (3) and the plate of posterior closing (21), forming the axial sealing among the divisors components (17a), (17b) and (17c) and the plates of anterior closing (3) and the plate of posterior closing (21), being each divisor component (17a), (17b) and (17c) is connected to the rotor (13) through its respective pivoted sliding guide element (15), which perfectly fit in the cylindrical cavities in the ends of the fissures (13a) of the rotor (13); also having a main axis component (8), formed by an axis of crankshaft type, containing cams (18a) and (18b), respectively, being the rotor (13) is to assembled over the cams (18a) and (18b), in a way of presenting free turn through an anterior bearing component (7) and a posterior bearing component (9), whose cams drive the movement of translation of the rotor (13), being this main axis is structured and stabilized by the fixed posterior bearing (22) and fixed anterior bearing (2) components, assembled in the central part of the posterior plate (21) and of the anterior plate (3), respectively, also being the rotor (13) has a rotation movement around its own axis, whose rotation movement is due to the interference of the satellite gear (13c), fixed to it, with the stationary planetary gear (20) fixed to any static element of the set that forms the engine (A).

2) “Internal Combustion Engine, Rotary Engine Type, with Distinct Conception, Durability and Performance, Applied to all Types of Vehicle or Industrial Equipment”, where its kinematics of movement during the phase of the functional cycle is characterized by the synchronized combination between the rotation movements of the rotor (13) around its own center and its orbital movement (translation), whose combination of movements makes this rotor (13) describes an orbital movement around the internal diameter of the jacket (6), whose center of the orbit coincide with the center of the jacket (6), being this movement resulting from the orbital turn of the cams (8a) and (8b), whose center of orbit coincides with the center of the main axis (8), which also coincides with the center of the jacket (6), being the cams (8a) and (8b) connected to the core of the rotor (13) through the bearings (7) and (9), in a sliding way, allowing free turn, where in the phase of maximal intake the reference divisor (17′) makes the tangency of one of the walls of the fissure (13a), forming an angle (α₁); in the phase of compression the reference divisor (17′) finds the medium point between the two walls of this fissure (13a), describing an angle (α₂); in the phase of explosion the reference divisor (17′) makes the tangency of one of the walls of this fissure (13a), forming an angle (α₃); in the phase of expansion the reference divisor (17′) is in the medium point between the two walls of the fissure (13a), forming an angle (α₄); and in the phase of depletion, the reference divisor (17′) makes the tangency of one of the walls of this fissure (13a), forming an angle (α₅), where in each phase of the functional cycle of the engine (A,) is assured a maintenance of a constant perpendicular angle (Θ2) equal to 90° between the end of the reference divisor (17′) and the internal surface of the jacket (6).

3) “Internal Combustion Engine, Rotary Engine Type, with Distinct Conception, Durability and Performance, Applied to all Types of Vehicle or Industrial Equipment”, in accordance with claim 1, where the rotor (13) is characterized by having the possibility of presenting its external part defined by any kind of geometric or organic form.

4) “Internal Combustion Engine, Rotary Engine Type, with Distinct Conception, Durability and Performance, Applied to all Types of Vehicle or Industrial Equipment”, in accordance with claim 1, where the rotary engine (A) is characterized by allowing the definition of “n” divisors components to the definition of “n” chambers of functional cycle of explosion and allowing the definition of “n” functional cycles to each one of the “n” chambers during a complete turn (360°) of the rotor around its own axis, combined with “n” orbits described by the rotor, resulting from “n” turns of the main axis, crankshaft type, around its own center, also allowing this engine (A) to define arrangements such as assembly in parallel of “n” engine sets (A), coupled among themselves or not, driving “n” axis, coupled among themselves or not.

5) “Internal Combustion Engine, Rotary Engine Type, with Distinct Conception, Durability and Performance, Applied to all Types of Vehicle or Industrial Equipment”, in accordance with claim 1, where the rotary engine (A) is characterized by allowing any kind of specification related to gears.

6) “Internal Combustion Engine, Rotary Engine Type, with Distinct Conception, Durability and Performance, Applied to all Types of Vehicle or Industrial Equipment”, in accordance with claim 1, where the rotary engine (A) is characterized by being applied in any kind of conception of internal combustion engine, also known as explosion engine, mainly two- or four-stroke-cycle.
